(19) United States
(12) Patent Application Publication
(10) Pub. No.: US 2007/0043857 A1
(43) Pub. Date: Feb. 22, 2007

(54) Method and System to Accelerate Data Processing for Mal-ware Detection and Elimination In a Data Network

(75) Inventors: Hao Hai Yao, San Jose, CA (US); Gordon Lu, Saratoga, CA (US); Baodung Nguyen, San Jose, CA (US); Rueysing Wei, Fremont, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Anchiva Systems, Inc.

(21) Appl. No.: 11/461,756

(22) Filed: Aug. 1, 2006

Related U.S. Application Data
(60) Provisional application No. 60/708,803, filed on Aug. 16, 2005.
(60) Provisional application No. 60/708,703, filed on Aug. 16, 2005.
(60) Provisional application No. 60/708,702, filed on Aug. 16, 2005.

(51) Int. Cl. G06F 15/173; G06F 15/16

(52) U.S. Cl. 709/224; 709/232

(57) ABSTRACT

A method and system to accelerate data processing for mal-ware detection and elimination in a data network are disclosed. In one embodiment, the method comprises receiving a first data stream via a data transmission medium; storing the first data stream in a first-in-last-out stack with additional data; receiving a second data stream; searching the first-in-last-out stack to find a matching data stream, the data stream having a scan status; and associating the scan status with the second data stream if the matching data stream is found.

The present application claims the benefit of and priority to U.S. Application No. 60/708,803 entitled “Self-Adaptive Scheme of Load Sharing Between a Software Implemented Algorithm and Hardware Accelerated Engine for the Algorithm” filed on Aug. 16, 2005, which is incorporated herein by reference.

The present application claims the benefit of and priority to U.S. Application No. 60/708,703 entitled “Method of Network Traffic Data Processing Acceleration Through The Elimination of Redundant Scanning” filed on Aug. 16, 2005, which is incorporated herein by reference.

The present application claims the benefit of and priority to U.S. Application No. 60/708,702 entitled “Method of Accelerated Internet Mail Content Scanning” filed on Aug. 16, 2005, which is incorporated herein by reference.

### FIELD OF THE INVENTION

The field of the invention relates generally to computer systems and more particularly relates to a method and system to accelerate data processing for mal-ware detection and elimination in a data network.

### BACKGROUND OF THE INVENTION

To guard against the malicious attacks of propagating virus, worms, Trojan horses, spy-ware agents, collectively known as mal-ware, a detection system scans the content of network data traffic for signatures and stops their propagation. To prevent a scanning device from detecting the malicious element, the mal-ware disseminator often floods the network with a storm of mal-ware to exhaust the detection device's resource and exploit any vulnerability under such a condition. With a naïve scanning algorithm, every one of the streams will need to be scanned, incurring an extremely high load on the detection device. Also, the virus, worms, and other malicious elements are often embedded in a compressed email attachment or are part of a compressed downloaded file. Detecting the malicious elements requires compute-intensive decompression before the data stream can be scanned for the offending element. When flooding the network with mal-ware, the mal-ware disseminator often performs multiple iterations of compression on the stream to be disseminated. This further increases the processing load of the detection device. Any pre-processing to reduce unneeded scanning alleviates the scanning device of the load and allows it to proceed to perform scanning on other potentially virulent streams.

To further protect against propagating virus and worms specifically in malicious emails, a detection device scans the email attachments for malicious content. Emails transmitted over the Internet are encoded in the MIME format. MIME stands for Multipurpose Internet Mail Extensions, and refers to an official Internet standard that specifies how messages are formatted so that they can be exchanged between different email systems. MIME is a flexible format, permitting one to include virtually any type of file or document in an email message. Specifically, MIME messages can contain text, images, audio, video, or other application-specific data. To insure that email messages containing images or other non-text information will be delivered with maximum protection against corruption, MIME provides a way for non-text information to be encoded as text. This encoding is known as base64. When a binary file is to be sent via email, the file is MIME-encoded and inserted as an attachment. Malicious attackers have used this binary attachment for mal-ware propagation via e-mail. Prior to scanning for malicious content, the original attachment is decoded using the reverse of the encoding mechanism of base64 to recover the original binary form.

### SUMMARY

A method and system to accelerate data processing for mal-ware detection and elimination in a data network are disclosed. In one embodiment, the method comprises receiving a first data stream via a data transmission medium; storing the first data stream in a first-in-last-out stack with additional data; receiving a second data stream; searching the first-in-last-out stack to find a matching data stream, the data stream having a scan status; and associating the scan status with the second data stream if the matching data stream is found.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of an exemplary data network and data processing device, according to one embodiment of the present invention.

FIG. 2 illustrates a block diagram of an exemplary scanning device, according to one embodiment of the present invention.

FIG. 3 illustrates a block diagram of an exemplary protocol processor hash-code operation, according to one embodiment of the present invention.

FIG. 4 illustrates the format of a MIME encoded email message 400, according to one embodiment of the present invention.

FIG. 5 illustrates an exemplary block diagram of an exemplary hash-code stack, according to one embodiment of the present invention.

FIG. 6 illustrates a block diagram of an exemplary scan task dispatcher, according to one embodiment of the present invention.

FIG. 7 illustrates a block diagram of an exemplary task queue with self-adjusted water-marks for balancing the load between hardware and software processing, according to one embodiment of the present invention.

### DETAILED DESCRIPTION

A method and system to accelerate data processing for mal-ware detection and elimination in a data network are disclosed. In one embodiment, a method comprises receiving a first data stream via a data transmission medium; storing the first data stream in a first-in-last-out stack with additional data; receiving a second data stream; searching the first-in-last-out stack to find a matching data stream, the data stream having a scan status; and associating the scan status with the second data stream if the matching data stream is found.

According to one embodiment, the present performance enhancing mal-ware scanning system comprises a hash-code stack, an enhanced MIME decoding and MINE header identification scheme, and a scheme of load dispatching that balances the workload—enabling better utilization of the software and hardware components in the system.

The hash-code computation and hash-code stack management scheme accelerate network traffic data processing through the identification and elimination of redundant content scanning. As data enters the traffic processor, data fragments are reassembled to form a stream. Incomplete or malformed streams are rejected and deleted. When a complete stream is found, a checksum is generated for the stream for identification. This checksum (along with other information) forms the signature that identifies the stream. One embodiment uses the MD5 sum as the signature. A stack of First-In-Last-Out (FILO) data is maintained for tracking the most recently scanned streams. Each entry of the FILO stack contains a stream signature, a timestamp, and a scanned or processed status. As a stream is received, the FILO stack is searched for the presence of the computed signature. If found, the FILO entry is validated by a comparison of the current time with the timestamp in FILO entry. If the current receive time also falls within a set limit, the stream is deemed the same as a previously processed stream of the same signature. The processed status from the FILO entry is returned as the current scan-status for this stream, skipping the redundant rescanning of the stream. Otherwise, a scan is performed on the stream. A new entry is allocated on the FILO. The signature, along with the scanned result is stored in the newly allocated entry. When the timestamp is found to be outside of the set limit (eg. one minute), the entry is removed from the FILO. This aging process limits the possibility of misidentifying two unrelated streams to be the same. Streams that are sent far-apart in time are unlikely to be the result of a malicious attack and they do not present a stressful condition on the processing device.

The MIME encoding scheme defines the format of multi-part messages. When new mail messages are composed, they are encoded prior to transmission. At the receiving side, the mail traffic processor decodes them to recover their original form. In the conventional approach, as mail traffic enters a mail processor, the mail message processor immediately proceeds to perform MIME parsing and decoding. The decoding process also decomposes a mail message into its sections. Then the mail message processor scans all the decoded binary sections for mal-wares.

In one embodiment, the email protocol processor includes a pre-scan phase and a faster string searching scheme. When a complete email stream is received, a pre-scan is performed. The purpose of the pre-scan is to identify whether there is a binary attachment. If no binary attachment of vulnerable file types is present, the entire MIME parsing and decoding is skipped, significantly speeding up anti-mal-ware processing of mail messages.

In an effort to improve system performance of the pattern scanning of all data traffic, scanning algorithms implemented in software are diverted to a hardware acceleration device, such as a specialize processor. A portion of the software process is re-implemented in a Field Programmable Gate Array (FPGA) or Application Specific Integrated Circuit (ASIC). This usually results in an intermediate hybrid implementation with software relegated to a control role interfacing with the hardware providing acceleration.

After a scanning process is re-implemented in hardware, software is used to delegate data processing to the hardware engine containing the FPGA or ASIC. Sometimes, under a high data load condition, the load on the CPU is relatively light while the hardware acceleration engine is stressed beyond capacity. Outstanding tasks are pending in a queue awaiting processing. In a system in which hardware acceleration offers less than high orders of magnitude speedup, this imbalance leaves the CPU underutilized at a time when the CPU could be put to use to significantly alleviate the load.

Accordingly, in one embodiment an enhanced scan task dispatcher provides workload balancing. A task processing mechanism is implemented both as a software program executing on a CPU as well as logic in an FPGA or ASIC hardware engine. Tasks can be dispatched to execute on the CPU or to be processed on the hardware accelerated engine. The status of a task is tracked in a task queue with a count of total number of outstanding tasks. Initially on startup when the queue is clear, all tasks are sent to the hardware processing element. As the count of outstanding tasks exceeds the high water mark threshold of the queue, processing is diverted to the CPU using invocation of the software process. The count of outstanding tasks on the hardware queue continues to be monitored. The dispatching to software continues until the count drops below the low water mark of the hardware queue. Processing then reverts to the specialized processor. New tasks are sent to the specialized processor for execution.

According to one embodiment, the low water mark is set depending on how fast the hardware acceleration engine drains the queue of tasks relative that of the software subsystem. Similarly, the high water marking is set depending on how fast tasks arrive for processing. Self adaptation is achieved by examining the number of tasks pending during a switchover between queuing for software processing and that for hardware processing. When the low water mark is crossed and the number of outstanding tasks queued for software processing is greater than the high water mark number, the high water mark is decremented. When the high water mark is crossed, the number of outstanding tasks queued for software processing is examined to see if this number is less than the low water mark number. If true, the low water mark is incremented. Over time, these water marks self-adjust to operate optimally to the operating condition of the system.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

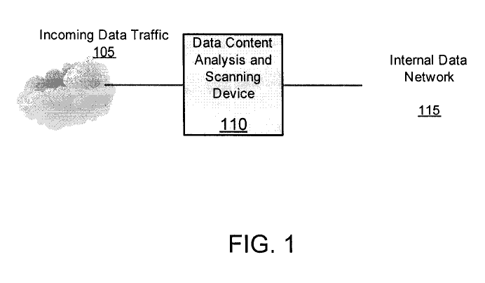

FIG. 1 illustrates a block diagram of an exemplary data network and data processing device, according to one embodiment of the present invention. Incoming data traffic 105 may be packet data that contains e-mail from the Internet or other data network. Scanning device 110 analyzes the data to detect and eliminate mal-ware before reaching an internal data network 115. Internal data network 115 may be a local area network for a business, enterprise network, or similar secure data network.

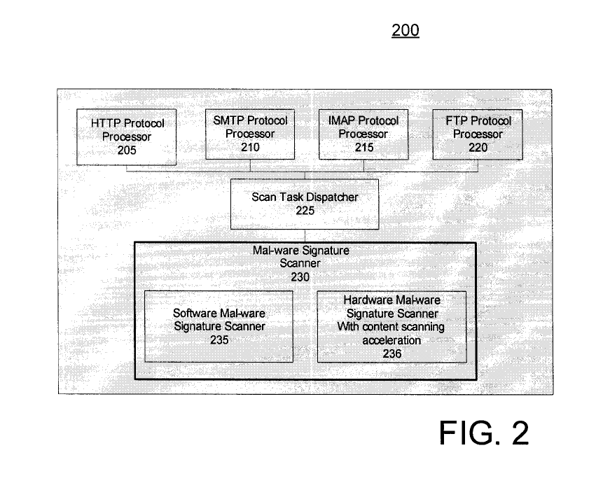

FIG. 2 illustrates a block diagram of an exemplary scanning device, according to one embodiment of the present invention. The scanning device 200 comprises various protocol processors, such as an HTTP Protocol Processor 205, SMTP Protocol Processor 210, IMAP Protocol Processor 215, and FTP Protocol Processor 220. The scanning device also includes a scan task dispatcher 225. A mal-ware signature scanner 230 has a software signature scanner 235 as well as a hardware signature scanner 236. Data packets enter the scanning device from a network interface (not shown). As each data packet is received, it is classified and then dispatched to the appropriate protocol processor-HTTP 205, SMTP 210, IMAP 215, or FTP 220. Once the appropriate protocol processor receives data packets, it begins assembling the fragmented packets into a coherent stream. A hash-code checksum is computed for the stream.

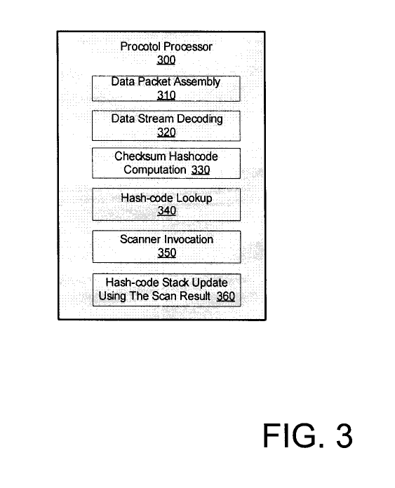

FIG. 3 illustrates a block diagram of an exemplary protocol processor hash-code operation 300, according to one embodiment of the present invention. When a protocol processor 300 receives data, it assembles the data packets (310). The protocol processor 300 decodes the data stream (320) and performs a checksum hash code computation (330). The hash-code is looked-up and verified (340) The protocol processor (300) then scans the data stream for mal-ware (350). Once the scan is complete, a hash-code stack is updated with the results of the scan for the particular data stream (360).

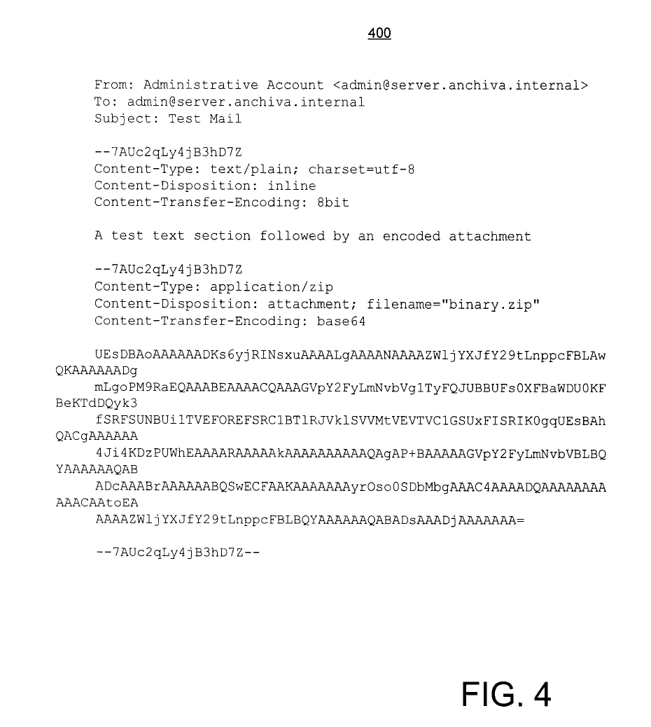

FIG. 4 illustrates the format of a MIME encoded email message 400, according to one embodiment of the present invention. A MIME encoded mail message 400 consists of several sections. A binary attachment appears in a section with header “Content-Transfer-Encoding:base64” and “Content-Disposition: attachment”. The sections can be pre-scanned with an accelerated fast string search algorithm, since there are no repeating prefix's in any of the header label and value fields.

In pre-scanning, the examination for the presence of a binary attachment involves a search for a MIME section with an “attachment” content-disposition. This is done by treating the entire email stream as a string and using an accelerated substring search for the field name of content-disposition and a field value of attachment. A substring search approach uses a generalized substring search that handles repeated prefixes in the substring.

Consider the case that a string search is performed, and the substring pattern is “AAAB” and the stream text is “AAAXAAAAA”. The first test will fail when the “B” in the pattern fails to match the fourth character in the text, which is an “X”. At this point, a general brute-force algorithm shifts the pattern by one position and starts over. The test restarts with a stream location pointing to the second character of “A” and the pattern location pointing to the first character “A”. In the pre-scan process of the present method, the search process is accelerated to one of shifting the pattern past the last failed comparison. Unlike a general substring search, the substrings of interest do not contain repeated prefixes. There is no repeated prefix in either the pattern “content-disposition” or the pattern “attachment.” Combining the accelerated substring search with a pre-scan phase, processing emails requiring mal-ware scanning is significantly accelerated.

If the stream is determined to require scanning, it is first decoded. Once a stream is decoded, the decoded data stream is passed to the scan task dispatcher 225.

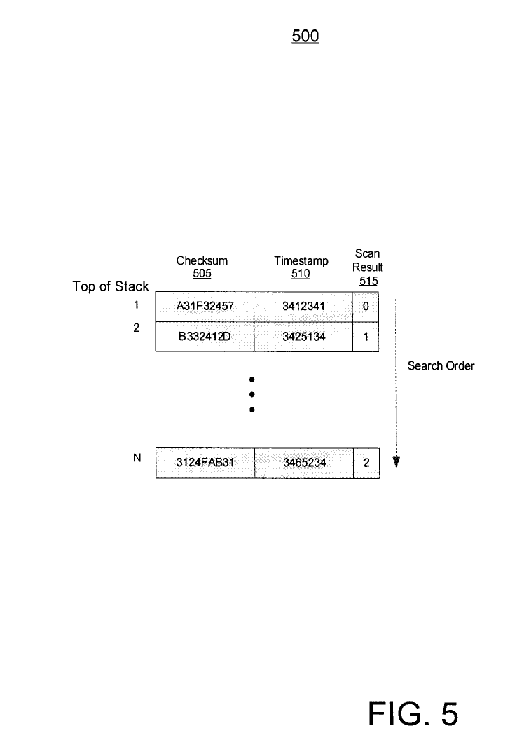

FIG. 5 illustrates an exemplary block diagram of an exemplary hash-code stack, according to one embodiment of the present invention. The hash-code stack 500 includes a checksum 505, timestamp 510 and scan result 515 for each entry 1-N. New entries are inserted on the top of the stack 500. Searches for a matching stream signature start from the top of stack 500 so the most recently entered entries are first examined. As new entries are inserted in the stack 500, previous entries, the oldest in time, fall off the bottom of the stack.

When the computed hash-code is not found in the scan stack, there is a need to perform a scan on the stream. The protocol processor 300 proceeds to decode the stream. For SMTP traffic, the data stream is processed by the SMTP protocol processor. The decoding needed is MIME decoding. A SMTP pre-scan and fast MIME field search process is invoked to determine if the content requires a full scan.

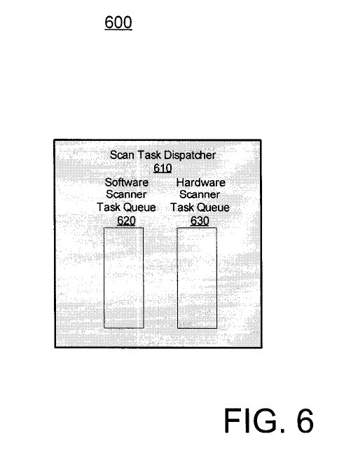

FIG. 6 illustrates a block diagram of an exemplary scan task dispatcher, according to one embodiment of the present invention. The scan task dispatcher 610 maintains a pair of task queues, a software task queue 620 and a hardware task queue 630. The software scanner task queue 620 represents the queue for processing mal-ware scans on data streams using a general purpose processor, such as the CPU of a PC. Hardware scanner task queue represents the queue for processing mal-ware scans on data streams using a specialized processor.

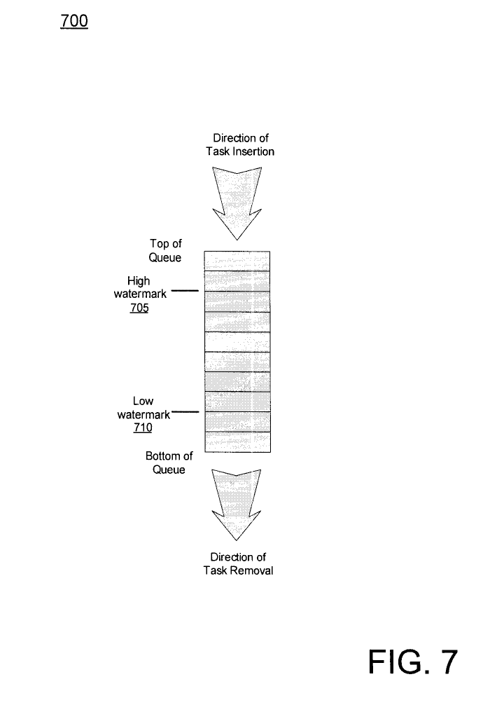

FIG. 7 illustrates a block diagram of an exemplary task queue 700 with self-adjusted water-marks for balancing the load between hardware and software processing, according to one embodiment of the present invention. Task queue 700 accepts new tasks from the top of the queue and removes tasks from the bottom of the queue. A high watermark 705 indicates tasks are backed up in the queue and requires a switchover of the queues. A low watermark 710 indicates that the tasks have returned to a level where the specialized processor can handle the data traffic without software processing by a general purpose processor. The watermarks may be optimized to automatically trigger load balancing between the general purpose processor and the specialized mal-ware processor.

Although the present method and system have been described in connection with a data network having mal-ware, one of ordinary skill would understand that the techniques described may be used in any situation where it is to integrate a software update service with a software application.

A method and system to accelerate data processing for mal-ware detection and elimination in a data network have been disclosed. Although the present methods and systems have been described with respect to specific examples and subsystems, it will be apparent to those of ordinary skill in the art that it is not limited to these specific examples or subsystems but extends to other embodiments as well.

We claim:

1. A method, comprising:
receiving a first data stream via a data transmission medium;
storing the first data stream in a first-in-last-out stack with additional data;
receiving a second data stream;
searching the first-in-last-out stack to find a matching data stream, the data stream having a scan status; and
associating the scan status with the second data stream if the matching data stream is found.

2. The method of claim 1, further comprising scanning the second data stream for mal-ware if the matching data stream is not found.

3. The method of claim 2, wherein the additional data comprises one or more of: a timestamp, a data stream signature, and scan result and a checksum value.

4. The method of claim 2, further comprising:
decoding the second data stream; and
calculating a checksum hash-code.

5. The method of claim 4, further comprising pre-scanning the second data stream to identify MIME header keywords.

6. A method, comprising:
detecting if a specialized processor for detecting mal-ware is reaching a first processing capacity threshold; and
diverting tasks from the specialized processor to a general purpose processor if the first processing capacity threshold is met.

7. The method of claim 6, further comprising:
detecting if the specialized processor is reaching a second processing capacity threshold; and
diverting tasks from the general purpose processor to the specialized processor if the second processing capacity threshold is met.

8. The method of claim 7, further comprising maintaining a first task queue for the specialized processor, the first task queue having the first processing capacity threshold and the second processing capacity threshold automatically adjusted to optimize diverting tasks from the specialized processor to the general purpose processor.

9. The method of claim 7, further comprising maintaining a second task queue for the general processor, the second task queue having the first processing capacity threshold and the second processing capacity threshold automatically adjusted to optimize diverting tasks from the specialized processor to the general purpose processor.
